(19) United States
(12) Patent Application Publication
(10) Pub. No.: US 2009/0114310 A1
(43) Pub. Date: May 7, 2009

(54) DISPENSING APPARATUS

(75) Inventor: Lucio Conforti, Fornovo Taro (IT)

Correspondence Address: NIXON & VANDERHYE, PC, 901 NORTH GLEBE ROAD, 11TH FLOOR, ARLINGTON, VA, 22203, US

(73) Assignee: SIDEL S.P.A., Parma (IT)

(21) Appl. No.: 12/298,851

(22) PCT Filed: Apr. 27, 2007
(86) PCT No.: PCT/EP2007/054199

§ 371 Date: Dec. 29, 2008

(30) Foreign Application Priority Data
Apr. 28, 2006 (IT) MO2006A000136

(51) Int. Cl. B67C 3/26

(52) U.S. Cl. 141/198; 141/392

(57) ABSTRACT

A dispensing apparatus comprises a cannula which is externally wrapped by a coaxial jacket so as the cannula can keep a plurality of angular positions with respect to the jacket, the cannula being provided with a first opening and the jacket being provided with a second opening, the second opening being arranged for cooperating with the first opening to define a breather passage through the jacket and through the cannula, the first opening and the second opening being shaped so as to define a longitudinal position for the breather passage, the longitudinal position depends on a relative angular position between the jacket and the cannula.

### CROSS-REFERENCE TO RELATED APPLICATIONS

This application is the U.S. national phase of International Application No. PCT/EP2007/054199, filed 28 Apr. 2006, which designated the U.S. and claims priority to Italy Application No. M02006A000136, filed 28 Apr. 2006, the entire contents of each application is hereby incorporated by reference.

The invention relates to a dispensing apparatus for dispensing a determined quantity of liquid product into a container.

In particular, the invention relates to a dispensing apparatus which is associable with filling heads of filler machines used for filling containers with liquid products.

Dispensing apparatuses are known provided with a cannula which extends longitudinally along a vertical axis and which is arranged for being inserted at least partially in a container to be filled.

The cannula has the function of enabling the air contained in the container to come out, and of enabling the liquid product, at first contained in an overlying tank, to fill the container.

The cannula is provided on a lateral surface thereof with an opening arranged for acting as a breather for the air contained in the container.

When the liquid product poured in the bottle has reached a level at which the liquid product obstructs the opening, the air is no longer evacuated and the transferring operation of the liquid product automatically stops.

By raising or lowering the opening with respect to the bottom of the container, it is possible to fill the container with a greater or lesser level of the liquid product or fill containers having different volumetric capacities.

A drawback of the above-described dispensing apparatuses is the need to replace the cannula whenever the quantity of liquid product to be poured in the bottle is to be varied and subsequently to assemble a new cannula which has the breather opening in the desired position.

This involves an undesirable loss of time.

An object of the invention is to improve dispensing apparatuses of liquid products.

A further object is to obtain a dispensing apparatus which enables a container to be filled with a desired quantity of liquid product without any need for replacing the cannula from time to time.

A still further object is to provide a dispensing apparatus which is easy to realise and has contained costs.

According to the invention, a dispensing apparatus is provided, comprising a cannula which is externally wrapped by a coaxial jacket so as said cannula can keep a plurality of angular positions with respect to said jacket, said cannula being provided with a first opening and said jacket being provided with a second opening, said second opening being arranged for cooperating with said first opening to define a breather passage through said jacket and through said cannula, said first opening and said second opening being shaped so as to define a longitudinal position for said breather passage, said longitudinal position depends on a relative angular position between said jacket and said cannula, said first opening being defined by a first slit of a first lateral wall of said cannula and said second opening being defined by a second slit of a second lateral wall of said jacket.

Owing to the invention, a dispensing apparatus can be realised which enables a quantity and/or a level of liquid product dispensed to be varied without any need to replace the cannula.

In fact, by rotating the cannula with respect to the jacket, a plurality of longitudinal positions can be defined for the breather passage through which the air contained in the container comes out. This enables to vary the quantity and/or the level of liquid product in the container.

This enables the setting time for replace the cannula to be avoided, and the structural complications of the filling head to be highly reduced, with a consequent economic advantage.

The invention can be better understood and implemented with reference to the enclosed drawings, that show some exemplifying and non limitative embodiments thereof, in which:

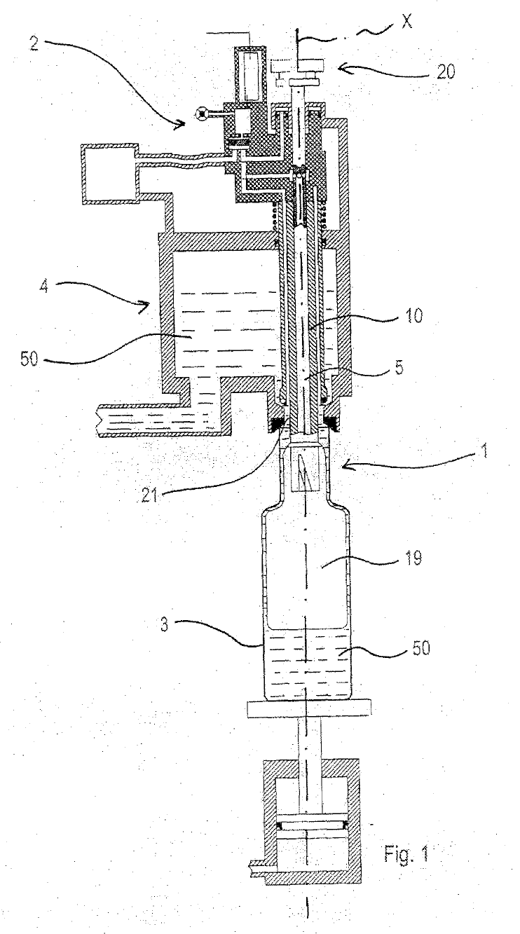

FIG. 1 is a partially sectioned and fragmentary schematic front view of a dispensing apparatus of a filling head;

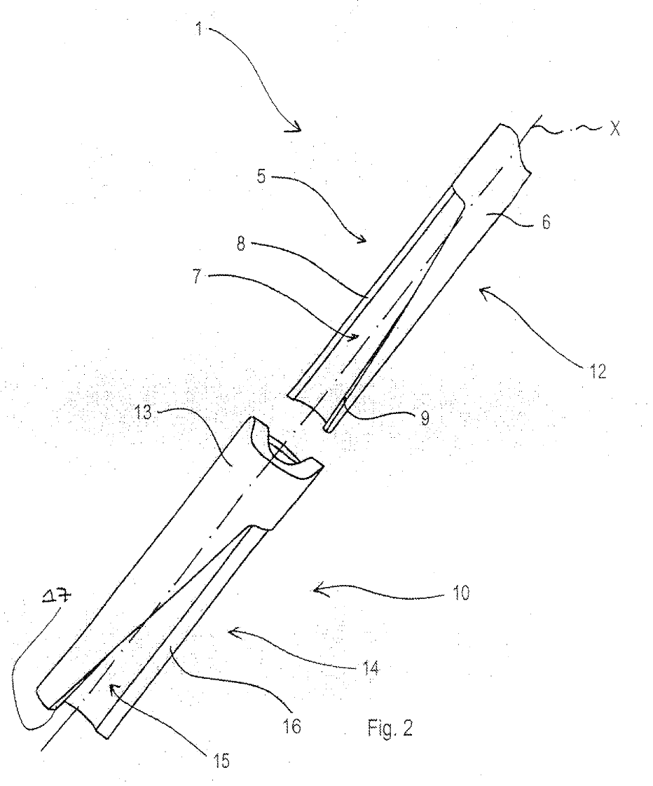

FIG. 2 is a fragmentary and enlarged perspective view of the dispensing apparatus of FIG. 1;

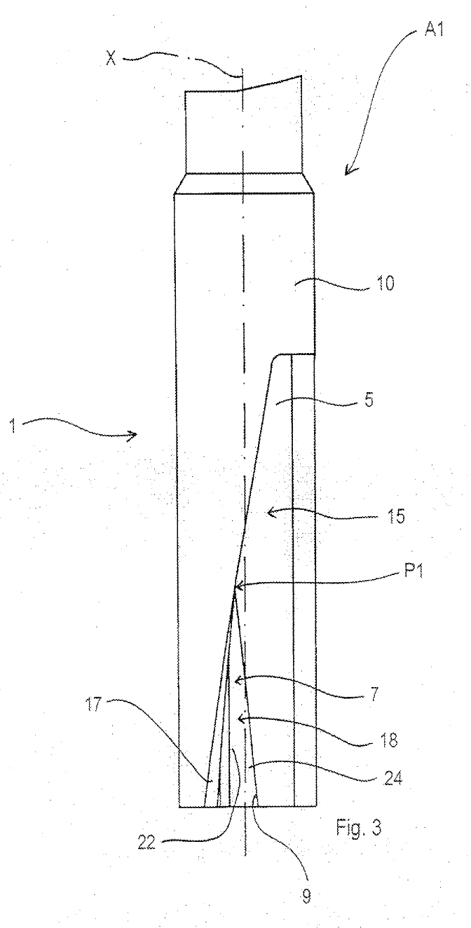

FIG. 3 is a fragmentary front view of the dispensing apparatus of FIG. 1 in a first operative configuration;

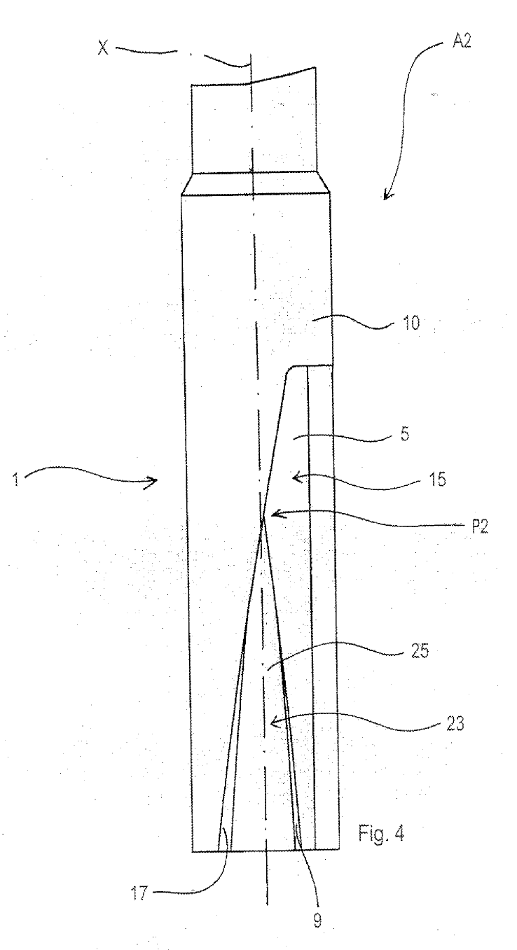

FIG. 4 is a fragmentary front view of the dispensing apparatus of FIG. 1 in a second operative configuration;

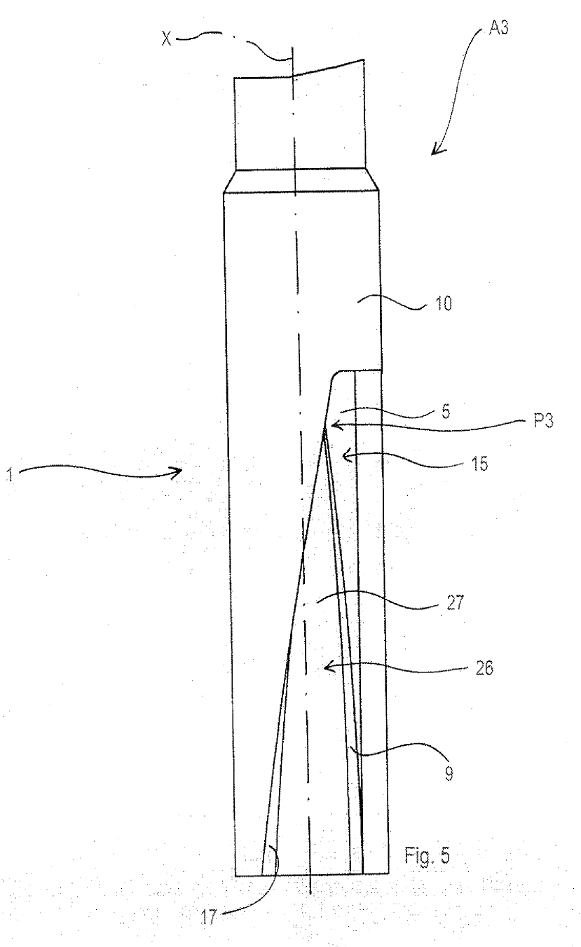

FIG. 5 is a fragmentary front view of the dispensing apparatus of FIG. 1 in a third operative configuration;

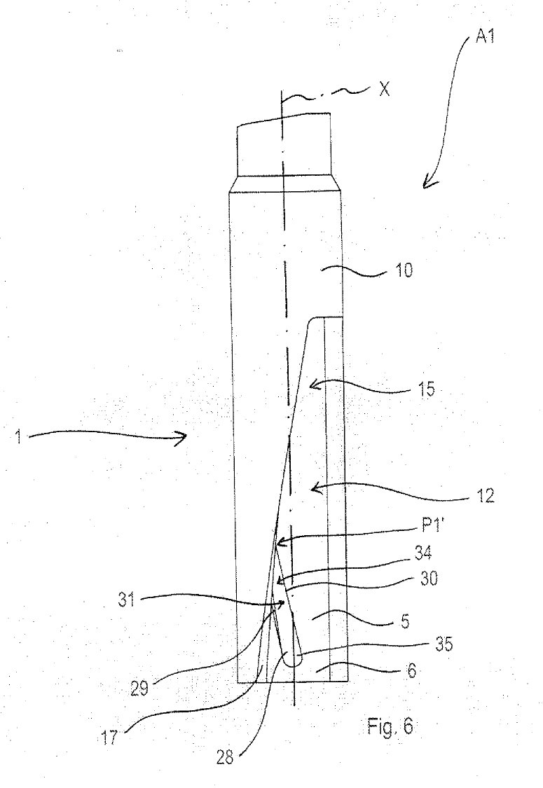

FIG. 6 is a fragmentary front view of a further embodiment of the dispensing apparatus of FIG. 1 in the first operative configuration;

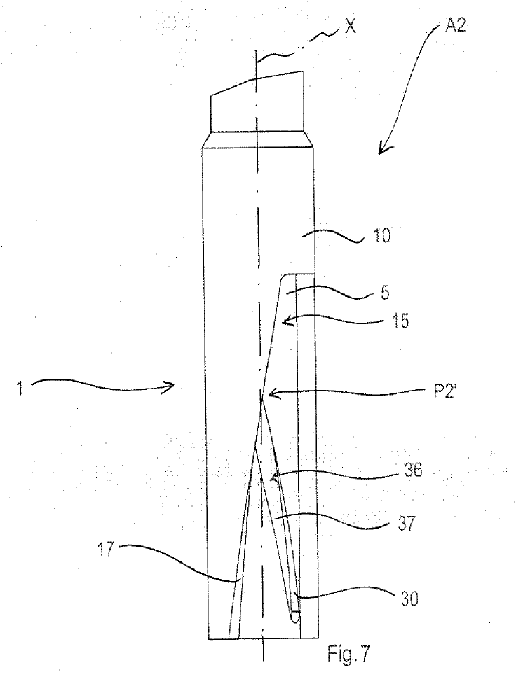

FIG. 7 is a fragmentary front view of the further embodiment of the dispensing apparatus of FIG. 1 in the second operative configuration;

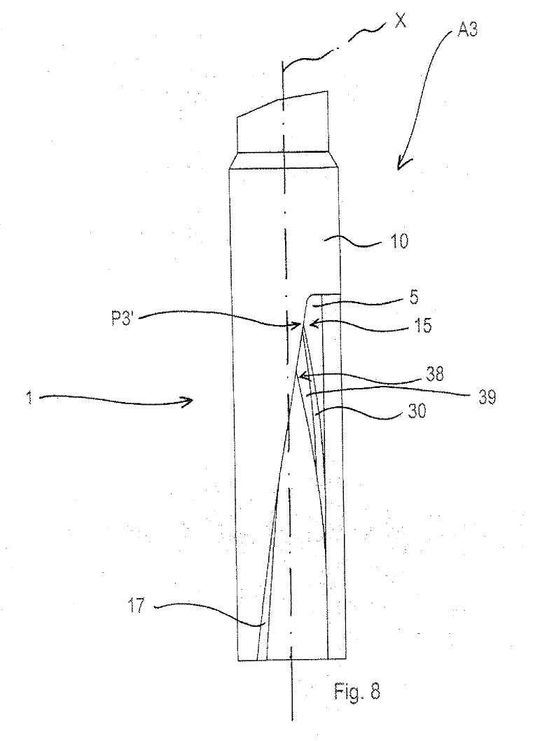

FIG. 8 is a fragmentary front view of the further embodiment of the dispensing apparatus of FIG. 1, in the third operative configuration.

With reference to FIG. 1, a dispensing apparatus 1 is shown, associated with a filling head 2 of a filling machine, not illustrated, such apparatus 1 comprises a plurality of filling heads 2, each of which is arranged for filling a respective container with a filling liquid 50.

The filling head 2 comprises a storage tank 4 arranged for containing a determined quantity of a liquid product 50 intended for filling the containers 3.

The storage tank 4 contains a determined constant quantity of liquid product 50, so that the filling can be done by force of gravity at a filling speed which is substantially constant.

The dispensing apparatus 1 comprises a cannula 5, which is rotatable around, and which extends along, an axis X, which cannula being arranged, in use, for being inserted, at least partially, in the container 3 (FIGS. 1 and 2).

The cannula 5, illustrated in detail in FIGS. 2 to 5, is substantially tubular and is provided with a substantially cylindrical first lateral wall 6.

The cannula 5 further comprises an end portion 12, which is arranged for being at least partially inserted into the container 3, which end portion 12 comprises a first slit 7 which is realized in the first lateral wall 6 and which extends substantially along the axis X.

The first slit 7 comprises a first edge 8 which extends substantially parallel to the axis X, and a first active edge 9 which is sloped with respect to the axis X and is opposite the first edge 8.

The cannula 5 is further externally wrapped by a fixed and substantially coaxial jacket 10.

In such a way the cannula 5, which can rotate around the axis X, can realize a plurality of relative angular positions in respect to the jacket 10.

The jacket 10 is substantially tubular and is provided with a substantially cylindrical second lateral wall 13.

The jacket 10 further comprises an end zone 14 which is arranged for being at least partially inserted in the container 3 and which comprises a second slit 15 which is realized in the second lateral wall 13 and which extends substantially along the axis X.

The second slit 15 comprises a second edge 16 which extends substantially parallel to the axis X, and a second active edge 17 which is sloped with respect to the axis X and is opposite the second edge 16.

The second active edge 17 is further sloped with respect to the first active edge 9 and, in use, the second active edge 17 is arranged for intersecting the first active edge 9.

In use, a portion of the second slit 15 and a further portion of the first slit 7 cooperate, according to the angular position of the cannula 5 with respect to the jacket 10, to define a breather passage 18, arranged for facilitating the air 19 to come out of the container 3 in order to enable the container 3 to be filled with a desired quantity of liquid 50 (FIG. 3).

In other words, in use, the second active edge 17 and the first active edge 9 intersect, to define the breather passage 18, which breather passage 18 can keep a plurality of longitudinal end positions in accordance with the relative angular position between the cannula 5 and the jacket 10.

In an embodiment of the invention, the cannula 5 can keep any angular position with respect to the jacket 10.

In a further embodiment of the invention, the cannula 5 can be only kept in determined angular positions.

In use, the cannula 5 is manually rotated by acting on a free end 20 thereof (FIG. 1) or automatically rotated by using a driving device, not illustrated, with respect to the jacket 10, so as to define a desired longitudinal end position for the breather passage 18.

In use, the filling head 2 is raised so as to define a circular passage 21 which is arranged for being passed through by the filling liquid 50 which can thus flow from the storage tank 4 towards the underlying container 3 up to a desired level, which is a function of the longitudinal end position of the breather passage 18.

With reference to FIG. 3, the dispensing apparatus 1 is shown in a first operative configuration A1, in which a container 3 can be filled with a filling liquid 50 up to a first filling level.

In the first operative configuration A1 the cannula 5 is rotated by a first angle, not illustrated, with respect to the jacket 10.

In the first operative configuration A1 the first active edge 9 intersects the second active edge 17 so as to uncover a minimal portion 22 of the first slit 7; this enables a first breather passage 24 to be obtained which defines a first longitudinal end position P1.

In the first operative configuration A1, when the filling head 2 is raised, the filling liquid 50 begins flowing into the container 3 which at the same time empties itself of the air 19 contained therein.

In other words, during the filling operation, the filling liquid 50 increases the level thereof inside the container 3, while the air 19 is breathed out through the first breather passage 24, up to the level of the filling liquid 50 has reached the first longitudinal end position P1.

At this point, the air 19, no longer having a breather passage, is forced to remain inside the container 3 and inside the sealed chamber in which the container 3 is positioned so as to block the transferring of the filling liquid 50 from the storage tank 4.

This enables the container 3 to be filled with the filling liquid 50 up to the first filling level which is longitudinally positioned substantially at the first longitudinal end position P1.

With reference to FIG. 4, the dispensing apparatus 1 is shown in a second operative configuration A2 in which a container 3 can be filled with a filling liquid 50 up to a second filling level.

In the second operative configuration A2 the cannula 5 is rotated by a second angle, not illustrated, with respect to the jacket 10.

In the second operative configuration A2, the first active edge 9 intersects the second active edge 17 so as to uncover an intermediate portion 23 of the first slit 7; this enables a second breather passage 25 to be obtained which defines a second longitudinal end position P2.

The filling operations are performed substantially similarly to the way described for the first operative configuration A1, with the exception that the air 19 is breathed out up to the level of the filling liquid 50 has reached the second longitudinal end position P2.

This enables the container 3 to be filled with the filling liquid 50 up to the second filling level which is longitudinally positioned substantially at the second longitudinal end position P2.

With reference to FIG. 5, the dispensing apparatus 1 is illustrated in a third operative configuration A3, in which a container 3 can be filled with a filling liquid 50 up to a third filling level.

In the third operative configuration A3 the cannula is rotated by a third angle, not illustrated, with respect to the jacket 10.

In the third operative configuration A3, the first active edge 9 intersects the second active edge 17 so as to uncover a prevalent portion 26 of the first slit 7; this enables a third breather passage 27 to be obtained which defines a third longitudinal end position P3.

The filling operations are performed substantially similarly to the way described for the first operative configuration A1 and for the second operative configuration A2, with the exception that the air 19 is breathed out up to the level of the filling liquid 50 has reached the third longitudinal end position P3.

This enables the container 3 to be filled with the filling liquid 50 up to the third filling level, which is longitudinally positioned substantially at the third longitudinal end position P3.

In a further embodiment of the invention, not illustrated, the cannula, which is rotatable, is provided with a plurality of first slits, positioned along the first lateral wall one after another in such a way as to define a predetermined path, for example a spiral path.

In this embodiment, the jacket, which is fixed, is provided with a plurality of second slits, appropriately positioned along the second lateral wall, each of which second slits is arranged for cooperating with a corresponding first slit in order to define a respective breather passage positioned longitudinally at different heights according to the relative angular position defined by the cannula with respect to the jacket.

In this way, according to the angular position defined by the cannula with respect to the jacket, a desired first slit-second slit pair can be selected, which will correspond to a determined longitudinal position of the respective breather passage.

According to the breather passage selected, this enables the container to be filled with a desired quantity of filling liquid.

With reference to FIGS. 6 to 8, an embodiment of the dispensing apparatus 1 is illustrated which comprises the jacket 10, which is fixed, in which the cannula 5, which is rotatable, comprises, in the end portion 12 thereof, a slot 28 which extends, for example in a helical shape, along the first lateral wall 6.

The slot 28 comprises a further first edge 29 which is sloped with respect to the axis X and a further first active edge 30 also sloped with respect to the axis X and facing the further first edge 29.

In other words, the further first edge 29 and the further first active edge 30 are substantially mutually parallel.

The further first active edge 30 is also sloped with respect to the second active edge 17 of the jacket 10, and is arranged, in use, in such a way as to intersect the second active edge 17.

In use, a portion of the second active edge 17 and a further portion of the further first active edge 30 cooperate, according to the angular position of the cannula 5 with respect to the jacket 10, in order to define a further breather passage 31, functionally substantially similar to the breather passage 18.

In use, the cannula 5 is rotated with respect to the jacket 10 so as to define a desired longitudinal end position for the further breather passage 31.

With reference to FIG. 6, this embodiment of the dispensing apparatus 1 is illustrated in the first operative configuration A1.

In the first operative configuration A1, the further first active edge 30 intersects the second active edge 17 so as to uncover a further minimal portion 34 of the slot 28; this enables a further first breather passage 35 to be obtained which defines a further first longitudinal end position P1′.

The filling operations are performed in a substantially similar way as above described for the dispensing apparatus 1 which comprises the cannula 5 provided with the first slit 7, i.e. the air 19 is breathed out up to the level of the filling liquid 50 has reached the further first longitudinal end position P1′.

This enables the container 3 to be filled with filling liquid 50 up to a further first filling level which is positioned longitudinally substantially at the further first longitudinal end position P1′.

With reference to FIG. 7, this embodiment of the dispensing apparatus 1 is illustrated in the second operative configuration A2.

In the second operative configuration A2, the further first active edge 30 intersects the second active edge 17 so as to uncover a further intermediate portion 36 of the slot 28; this enables a further second breather passage 37 to be obtained which defines a further second longitudinal end position P2′.

The filling operations are performed in a substantially similar way as above described, i.e. the air 19 is breathed out up to the level of the filling liquid 50 has reached the further second longitudinal end position P2′.

This enables the container 3 to be filled with the filling liquid up to a further second filler level which is positioned longitudinally substantially at the further second longitudinal end position P2′.

With reference to FIG. 8, this embodiment of the dispensing apparatus 1 is shown in the third operative configuration A3.

In the third operative configuration A3, the further first active edge 30 intersects the second active edge 17 so as to uncover a further prevalent portion 38 of the slot 28, which enables a further third breather passage 39 to be obtained which defines a further third longitudinal end position P3′.

The filling operations are performed in a substantially similar way as above described, i.e. the air 19 is breathed out up to the level of the filling liquid 50 has reached the further third longitudinal end position P3′.

This enables the container 3 to be filled with filling liquid up to a further third filling level which is positioned longitudinally substantially at the further third longitudinal end position P3′.

In an embodiment of the invention, not illustrated, the cannula, that is rotatable, is provided with a plurality of slots, for example circular slots, arranged along the further first lateral wall one after another so as to define a determined path, for example a spiral path.

In this embodiment, the jacket, which is fixed, is provided with a plurality of slits, appropriately positioned along the lateral wall, each of which slits is arranged for cooperating with a corresponding slot in order to define a respective breather passage positioned longitudinally at different heights according to the relative angular position defined by the cannula with respect to the jacket.

In this way, according to the angular position defined by the cannula with respect to the jacket, a desired slot-slit pair can be selected, which will correspond to a determined longitudinal position of the respective breather passage.

According to the breather passage selected, this enables the container to be filled with a desired quantity of filling liquid.

1-11. (canceled)

12. Dispensing apparatus comprising a cannula which is externally wrapped by a coaxial jacket so as said cannula can keep a plurality of angular positions with respect to said jacket, said cannula being provided with a first opening and said jacket being provided with a second opening, said second opening being arranged for cooperating with said first opening to define a breather passage through said jacket and through said cannula, said first opening and said second opening being shaped so as to define a longitudinal position for said breather passage, said longitudinal position depends on a relative angular position between said jacket and said cannula, said first opening being defined by a first slit of a first lateral wall of said cannula and said second opening being defined by a second slit of a second lateral wall of said jacket.

13. Apparatus according to claim 12, wherein said longitudinal position is an end position of said breather passage.

14. Apparatus according to claim 12, wherein said first opening has a first active edge which extends along a longitudinal axis of said cannula.

15. Apparatus according to claim 14, wherein said first active edge is sloped with respect to said axis.

16. Apparatus according to claim 14, wherein said second opening has a second active edge which operationally intersects said first active edge.

17. Apparatus according to claim 16, wherein said second active edge is sloped with respect to said first active edge.

18. Apparatus according to claim 16, wherein said breather passage is defined between a portion of said first active edge and a remaining portion of said second active edge.

19. Apparatus according to claim 16, wherein said second active edge has at least a first angular position with respect to said first active edge in which said second active edge uncovers a minimal portion of said first opening.

20. Apparatus according to claim 19, wherein said second active edge has at least a second angular position with respect to said first active edge in which said second active edge uncovers an intermediate portion of said first opening.

21. Apparatus according to claim 20, wherein said second active edge has at least a third angular position with respect to said first active edge in which said second active edge uncovers a prevalent portion of said first opening.

22. Filling machine provided with a filling head comprising a dispensing apparatus according to claim 12.
